(19) United States
(12) Patent Application Publication
(10) Pub. No.: US 2022/0169137 A1
(43) Pub. Date: Jun. 2, 2022

(54) HOME ENERGY STORAGE LIFE CAPABILITY PREDICTIONS

(71) Applicant: FORD GLOBAL TECHNOLOGIES, LLC, Dearborn, MI (US)

(72) Inventors: Rachel A. BLASER, New Hudson, MI (US); Lan YU, Canton, MI (US); Michael W. DEGNER, Novi, MI (US)

(21) Appl. No.: 17/106,083

(22) Filed: Nov. 28, 2020

(51) Int. Cl. B60L 53/63; G06Q 10/04; G06Q 50/06; B60L 53/64; B60L 53/66

(52) U.S. Cl. CPC B60L 53/63; G06Q 10/04; G05B 2219/2639; B60L 53/64; B60L 53/66; G06Q 50/06

(57) ABSTRACT

This disclosure details systems and methods for selectively implementing new features within home energy storage systems based on a unique usage pattern associated with each individual home energy storage system. In exemplary embodiments, the unique usage patterns are used to predict the life and capability of each individual home energy storage system for supporting the launch, such as via a cloud-based update, of new features within such systems.

### TECHNICAL FIELD

This disclosure relates to home energy storage systems, and more particularly to systems and methods for selectively implementing new features within home energy storage systems based on a unique usage pattern associated with each individual home energy storage system.

### BACKGROUND

In general, electrified vehicles differ from conventional motor vehicles because they are selectively driven by one or more battery powered electric machines. Conventional motor vehicles, by contrast, rely exclusively on internal combustion engines to propel the vehicle.

Some vehicle customers may desire home energy storage systems that are capable of storing electricity locally for later consumption, such as for charging an electrified vehicle, supporting home energy needs, and/or as a portable power source for powering one or more electrical loads.

### SUMMARY

A home energy storage system life capability prediction and optimization system according to an exemplary aspect of the present disclosure includes, among other things, a data repository configured for storing battery usage data associated with each of a plurality of home energy storage system units, and a processor configured to assess an impact of a new home energy storage system feature on each of the plurality of home energy storage system units based on a unique usage pattern associated with each of the plurality of home energy storage system units.

In a further non-limiting embodiment of the foregoing system, the data repository is part of a memory device of a cloud-based server system.

In a further non-limiting embodiment of either of the foregoing systems, the processor is part of a cloud-based server system.

In a further non-limiting embodiment of any of the foregoing systems, the cloud-based server system includes a transceiver configured to communicate with a corresponding transceiver of each of the plurality of home energy storage system units for receiving the battery usage data.

In a further non-limiting embodiment of any of the foregoing systems, each of the plurality of home energy storage system units includes a battery array including a plurality of battery cells, a sensor system, a communication system, and a controller.

In a further non-limiting embodiment of any of the foregoing systems, the sensor system includes one or more sensors configured for monitoring various aspects associated with the battery cells.

In a further non-limiting embodiment of any of the foregoing systems, the various aspects include at least temperature, voltage, and current values associated with the battery cells.

In a further non-limiting embodiment of any of the foregoing systems, the processor is configured to derive the unique usage pattern associated with each of the plurality of home energy storage system units based on the battery usage data.

In a further non-limiting embodiment of any of the foregoing systems, the processor is configured to predict a future life capability of each of the plurality of home energy storage system units based on the unique usage pattern.

In a further non-limiting embodiment of any of the foregoing systems, the future life capability is further based on one or more battery degradation characteristics or one or more specifications of the plurality of home energy storage system units.

In a further non-limiting embodiment of any of the foregoing systems, the processor is configured to determine, based on the expected impact of the new home energy storage feature on each of the plurality of home energy storage system units, which units of the plurality of home energy storage system units the new home energy storage features should be implemented on.

In a further non-limiting embodiment of any of the foregoing systems, the processor is configured to command implementation of the new home energy storage feature on a first portion of the plurality of home energy storage system units and is further configured to command that the new home energy storage feature not be implemented on a second portion of the plurality of home energy storage system units.

In a further non-limiting embodiment of any of the foregoing systems, the new home energy storage feature is not implemented when an overall benefit of launching the new home energy storage feature will not outweigh any negative impact imposed on a future life capability.

A method according to another exemplary aspect of the present disclosure includes, among other things, selectively determining, via a processor of a server system, whether or not to implement a new feature within a first home energy storage system unit of a plurality of home energy storage system units based on a unique usage pattern associated with the first home energy storage system unit.

In a further non-limiting embodiment of the foregoing method, the method includes receiving and storing battery usage data associated with the first home energy storage system unit on a data repository of the server system.

In a further non-limiting embodiment of either of the foregoing methods, the method includes deriving the unique usage pattern of the first home energy storage system unit based at least on the battery usage data.

In a further non-limiting embodiment of any of the foregoing methods, the method includes predicting a future life capability of the first home energy storage system unit based on the derived unique usage pattern.

In a further non-limiting embodiment of any of the foregoing methods, the method includes assessing an impact of the new feature on the future life capability of the first home energy storage system unit.

In a further non-limiting embodiment of any of the foregoing methods, the method includes commanding installation of the new feature on the first home energy storage system unit when the impact of implementing the new feature is within the future life capability of the first home energy storage system unit.

In a further non-limiting embodiment of any of the foregoing methods, the method includes commanding that the new feature not be implemented on a second home energy storage system unit of the plurality of home energy storage system units when the impact of implementing the new feature is not within a future life capability of the second home energy storage system unit.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a structure that includes a home energy storage system.

FIG. 2 schematically illustrates an exemplary home energy storage system.

FIG. 3 schematically illustrates a home energy storage life capability prediction and optimization system.

FIG. 4 schematically illustrates an exemplary method that can be performed by the home energy storage life capability and optimization system of FIG. 3 for selectively implementing new features within each individual home energy storage system.

### DETAILED DESCRIPTION

This disclosure details systems and methods for selectively implementing new features within home energy storage systems based on a unique usage pattern associated with each individual home energy storage system. In exemplary embodiments, the unique usage patterns are used to predict the life and capability of each individual home energy storage system for supporting the launch, such as via a cloud-based update, of new features within such systems. These and other features of this disclosure are discussed in greater detail below.

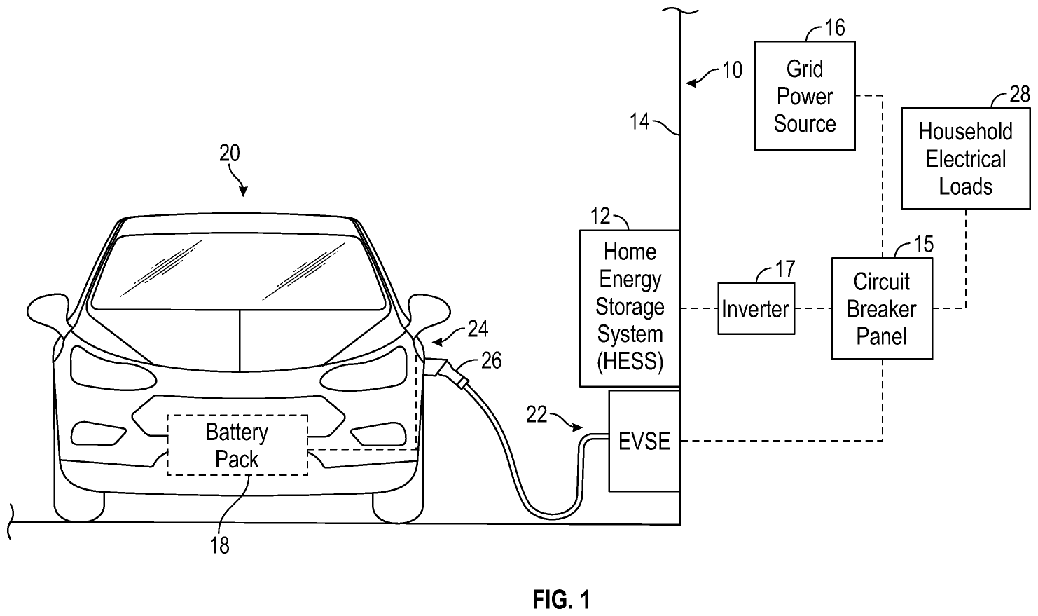

FIG. 1 schematically depicts select portions of a structure 10. The structure 10 could be a residential building, a commercial building, a parking garage, or any other type of structure. In an embodiment, the structure 10 is a garage of a residential home. It should be understood that the various components of FIG. 1 are shown schematically to better illustrate exemplary features of this disclosure and are not necessarily depicted to scale.

A home energy storage system (HESS) 12 may be mounted to a surface 14, such as a wall or a floor, of the structure 10. The HESS 12 may be electrically coupled to a grid power source 16 through a circuit breaker panel 15 that is operably connected to the grid power source 16. The grid power source 16 can supply power to the HESS 12. In an embodiment, the grid power source 16 is an AC power source that inputs power to the HESS 12. However, other power sources, including but not limited to solar, wind, or a combination of power sources, are further contemplated within the scope of this disclosure.

The power supplied to the HESS 12 may be locally stored for later consumption by various electrical loads. Thus, the HESS 12 can be used to power various electrical loads even when power is not available at the structure 10 from the grid power source 16.

In an embodiment, the HESS 12 may be employed to charge a traction battery pack 18 of an electrified vehicle 20 that is parked within or near the structure 10. The traction battery pack 18 is an exemplary electrified vehicle battery. The traction battery pack 18 may be a high voltage traction battery pack that includes a plurality of battery arrays (i.e., battery assemblies or groupings of rechargeable battery cells) capable of outputting electrical power to operate the electrical loads (e.g., electric motor) of the electrified vehicle 20. The electrified vehicle 20 may include any type of electrified powertrain and may be configured as a battery electric vehicle (BEV), a plug-in hybrid electric vehicle (PHEV), a fuel cell vehicle, etc. The electrified vehicle 20 could also be car, a pickup truck, a van, a sport utility vehicle, or any other type of vehicle.

The electrified vehicle 20 may interface with the HESS 12 through an electric vehicle supply equipment (EVSE) 22 that can be operably connected to a charge port assembly 24 of the electrified vehicle 20 for charging the traction battery pack 18. The EVSE 22 may include a charge coupler 26 that is configured to plug into one or more inlet ports of the charge port assembly 24 for transferring power from the HESS 12 to the traction battery pack 18. The EVSE 22 may be operably connected to the structure's 10 wiring through the circuit breaker panel 15. Power stored by the HESS 12 may be communicated to an inverter 17 that is configured for converting DC electrical power to AC electrical power. The power may then be communicated through the wiring of the structure 10 and then to the EVSE 22 for charging the traction battery pack 18.

The HESS 12 may also act as a backup power source for supporting various other household electrical loads 28 that are separate from the electrified vehicle 20. The household electrical loads 28 may include any home energy loads, including but not limited to, home appliances, home HVAC systems, home lighting systems, etc.

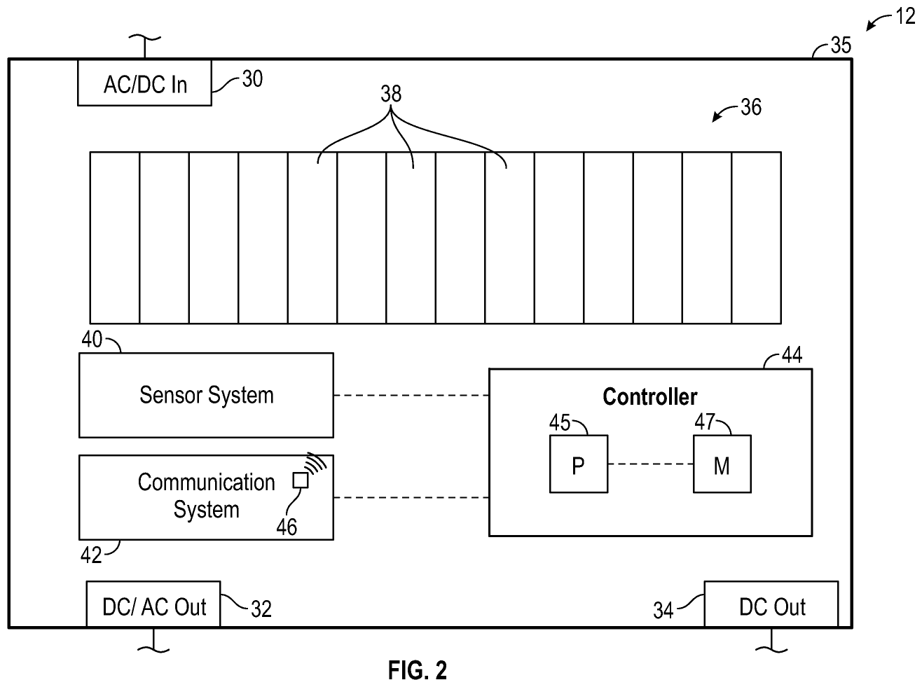

The exemplary HESS 12 of FIG. 1 is further illustrated in FIG. 2. The HESS 12 may include an AC/DC input 30, A DC/AC output 32, and a DC output 34. The AC/DC input 30 is configured for receiving power from the grid power source 16 (or other power sources). AC power can be delivered to external loads via the DC/AC output 32, and DC power can be delivered directly to external loads via the DC output 34.

The HESS 12 may include one or more battery arrays 36 for locally storing energy for later use. The battery array(s) 36 may be housed inside a sealed enclosure 35 of the HESS 12. Each battery array 36 may include a plurality of battery cells 38 or other energy storage devices capable of storing electrical power that is received from the grid power source 16. The energy stored in the battery cells 38 can be used to charge the traction battery pack 18 of the electrified vehicle 20 and/or to power the electrical loads 28, for example.

Although a specific number of battery cells 38 are depicted in FIG. 2, each battery array 36 could employ a greater or fewer number of battery cells 38 within the scope of this disclosure. Moreover, although a single battery array 36 is shown in FIG. 2, the HESS 12 could include a greater number of battery arrays within the scope of this disclosure.

In an embodiment, the battery cells 38 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

In another embodiment, the battery arrays 36 are repurposed batteries, such as repurposed electrified vehicle battery arrays. A repurposed electrified vehicle battery array is, for example, a battery array that is no longer able to fulfill the rigors of the relatively demanding vehicle propulsion duties but still has some available working capacity (e.g., 50% capacity or more). The repurposed battery array may include repurposed battery cells. In yet another embodiment, unused, or new battery arrays, or a mixture of new and used battery arrays, could be employed for use within the HESS 12.

The HESS 12 may additionally include a sensor system 40, a communication system 42, and a controller 44. The sensor system 40 may include one or more sensors that are configured to provide input signals to the controller 44. In an embodiment, the input signals include battery usage data associated with the battery array 36 and/or the battery cells 38. The sensor system 40 may be configured to monitor various aspects of the battery cells 38 of the battery array 36, such as temperature, voltage, current, etc. Other information associated with the battery cells 38 and/or the battery array 36 could alternatively or additionally be provided to the controller 44 by the sensor system 40 as part of the battery usage data.

The communication system 42 is configured for achieving bidirectional communication between the HESS 12 and a cloud-based server system. The communication system 42 may include one or more transceivers 46 for achieving the bidirectional communication and connectivity.

The controller 44 may control various operations associated with the HESS 12. The controller 44 may communicate command signals, diagnostic information, battery information, and other relevant information over communication paths for controlling the operations of the HESS 12. In an embodiment, the controller 44 is configured to manage charging and discharging operations of the battery array(s) 36. In another embodiment, as discussed in greater detail below, the controller 44 is configured to periodically command the communication system 42 to send, via the transceiver 46, battery usage data associated with the battery cells 38 and/or battery array 36 to a cloud-based server system for storage and analysis.

The controller 44 may include a processor 45 and non-transitory memory 47 that is operatively linked to the processor 45 for executing the various control strategies and modes of the HESS 12. The processor 45 can be programmed to execute one or more programs stored in the memory 47. The one or more programs may be software code that includes one or more additional or separate programs, each of which may include an ordered list of executable instructions for implementing logical functions.

The processor 45 may be a custom made or commercially available processor, a central processing unit (CPU), or generally any device for executing software instructions. The memory 47 can include any one or combination of volatile memory elements and/or nonvolatile memory elements.

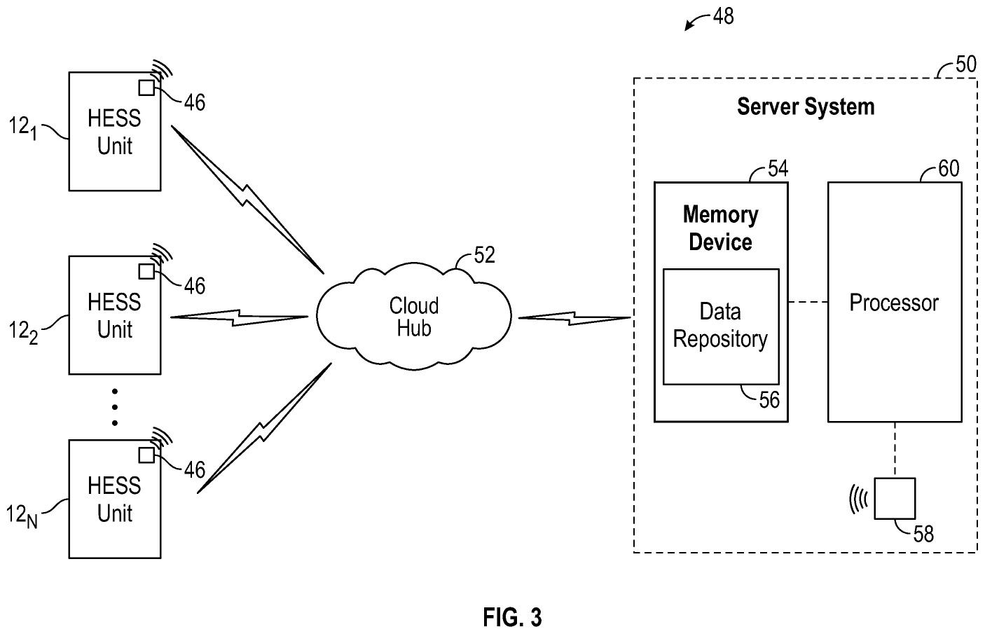

FIG. 3, with continued reference to FIGS. 1-2, schematically illustrates a home energy storage life capability prediction and optimization system 48 (hereinafter referred to as “the system”). Among other things, the system 48 is configured for selectively implementing new home energy storage features, such as in the form of selective software updates, within a given HESS based on a unique usage pattern associated with that particular HESS.

The system 48 includes a plurality of HESS units 12₁-12_{N}, where “N” represents any number. Each individual HESS unit 12₁-12_{N} associated with the system 48 may represent a different HESS located at a different structure and owned by a different user than the other HESS units 12₁-12_{N}. Together, the plurality of HESS units 12₁-12_{N} establish a network of HESSs.

Each individual HESS unit of the plurality of HESS units 12₁-12_{N} may communicate with a server system 50 over a cloud hub 52 (i.e., the internet) for storing information pertaining to the battery array(s) 36/battery cells 38 of each HESS unit. The server system 50 may include a memory device 54 with a HESS data repository 56, a transceiver 58, and a processor 60. The server system 50 is configured to receive battery usage data associated with each HESS unit of the plurality of HESS units 12₁-12_{N}. Through communication links established between the transceivers 46 of the HESS units and the transceiver 58 of the server system 50, the server system 50 may communicate with each individual HESS unit for receiving the battery usage data.

The transceivers 46, 58 may enable bidirectional communication between the HESS units 12₁-12_{N} and the server system 50. For example, the transceivers 46 can receive information from the transceiver 58 or can communicate data to the server system 50 via the employed communication techniques/protocols. Although not necessarily shown or described in this highly schematic embodiment, numerous other components may enable bidirectional communication between the HESS units 12₁-12_{N} and the server system 50. Communications between the HESS units 12₁-12_{N} and the sever system 50 may occur over a wireless link (e.g., cellular, Wi-Fi, Bluetooth, etc.), a direct Ethernet connection, or some combination of these.

The processor 60 of the server system 50 may be operatively linked to the memory device 54. The processor 60 can be programmed to execute one or more programs (e.g., algorithms) stored in the memory device 54.

The HESS data repository 56 may be part of the memory device 54. In an embodiment, the HESS data repository 56 represents a segment of the memory device 54 dedicated for storing battery usage data associated with each of the plurality of HESS units 12₁-12_{N}.

In an embodiment, the processor 60 is configured to execute one or more programs using the battery usage data stored in the HESS data repository 56 in order to derive a usage pattern or trend for each individual HESS unit of the plurality of HESS units 12₁-12_{N} and/or usage pattern/trends for HESS units associated with a particular geographical region. In another embodiment, the processor 60 is configured to execute one or more programs for predicting a future life capability over time for each HESS unit of the plurality of HESS units 12₁-12_{N} based on factors such as the derived usage patterns, battery degradation characteristics, and/or the specifications of each individual HESS unit. The battery degradation characteristics can refer to computer models that calculate lifetime of batteries in HESS units based on cycle degradation, calendar degradation, and battery chemistry. The specifications of each HESS unit can include characteristics such as SOC limits, capacity/system sizing, charge/discharge c-rate, etc.

The derived usage patterns may include HESS unit charging/discharging profiles developed based on historical HESS unit usage, residential electrical loads, and customer preferences and behaviors. Patterns could be sorted by various categories, e.g., demographic information, geographical region, weather, size/type of home, appliances, renewable energy resources, etc. For example, customers who live in a particular geographic region with similar size of house, similar size of appliances, similar number of EVs and renewable energy sources, etc. may have similar energy consumption pattern. Similarly, customers who share similar daily life behavior and energy usage preferences may share a similar energy management strategy. Thus, those groups of customer would have similar HESS unit usage (charging/discharging) profile over time.

In yet another embodiment, the processor 60 is configured to execute one or more programs for implementing new home energy storage related features within each individual HESS unit of the plurality of HESS units 12₁-12_{N} based on a correlation between the derived usage pattern and the predicted future life capability of each respective HESS unit. The new features may be completely new features and/or improvements to existing features and may be selectively implemented through a cloud-based update, for example. By way of non-limiting examples, the new home energy storage features could include a more or less aggressive electrical usage plan, an energy market plan for benefiting the grid power source, etc.

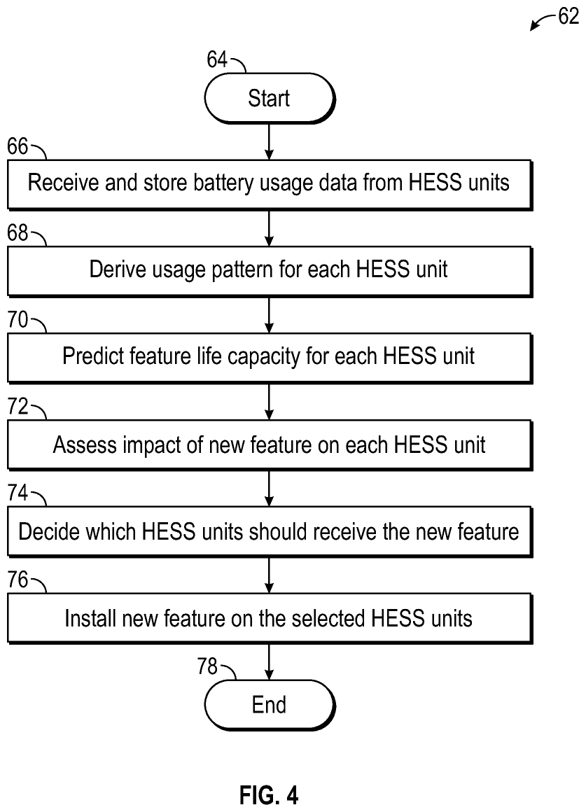

FIG. 4, with continued reference to FIGS. 1-3, schematically illustrates an exemplary method 62 that can be performed by the system 48 of FIG. 3 for selectively implementing new features within each individual HESS unit of the plurality of HESS units 12₁-12_{N} In an embodiment, the processor 60 of the server system 50 is programmed with one or more algorithms adapted to execute the exemplary method 62.

The exemplary method 62 may begin at block 64. At block 66, the server system 50 may periodically receive and store battery usage data from each individual HESS unit of the plurality of HESS units 12₁-12_{N}. The battery usage data may be communicated via the transceivers 46, 58 and may be stored in the HESS data repository 56 of the memory device 54.

Next, a block 68, the processor 60 may analyze the battery usage data associated with each individual HESS unit in order to derive one or more usage patterns associated with the plurality of HESS units 12₁-12_{N}. A derived usage pattern may be associated with each individual HESS unit or could be generalized for HESS units associated with a particular geographical region.

At block 70, the derived usage patterns obtained at block 68 may be used by the processor 60 for predicting a future life capability over time for each HESS unit of the plurality of HESS units 12₁-12_{N}. The processor 60 may consider other factors in addition to the derived usage patterns for predicting the future life capabilities of each of the HESS units, such as battery degradation characteristics and/or the specifications of each individual HESS unit, for example.

At block 72, the processor 60 may assess the impact that implementing one or more new features could have on the future life capabilities for each HESS unit. This assessment may include establishing a correlation between the derived usage patterns from block 68 and the predicted future life capabilities from block 70 to evaluate whether, and to what extent, implementing the new feature will impact the future life capabilities of each HESS unit. For example, from a derived usage pattern it can be determined how each HESS unit is being used based on data such as charge/discharge rates, percent of time spent at SOC level, temperature, kWh throughput, etc. The processor 60 may analyze these factors to predict battery life capabilities.

Next, at block 74, the processor 60 may determine, based on the impact predictions previously made at block 72, which HESS units of the plurality of HESS units 12₁-12_{N} that a given new feature should be implemented on. In an embodiment, only those HESS units in which the impact of implementing the new features is within that particular HESS unit's predicted future life capability are selected for implementing the new feature(s).

At block 76, the new feature(s) is installed on each individual HESS unit previously selected at block 74. The new feature(s) may be implemented via a cloud-based update in which the transceiver 58 of the server system 50 communicates with the transceivers 46 of each selected HESS unit. The processor 45 of each selected HESS unit may then implement the new feature as part of the ongoing functionality of the HESS unit. The method 62 may then end at block 78.

The systems and methods of this disclosure provide for determining and optimizing each individual HESS unit's life and capability for providing power to loads. The proposed systems and methods utilize battery usage data stored in the cloud to predict the life and capability for supporting the launch of new home energy storage features on an individual HESS unit basis.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A home energy storage system life capability prediction and optimization system, comprising:
a data repository configured for storing battery usage data associated with each of a plurality of home energy storage system units; and
a processor configured to assess an impact of a new home energy storage system feature on each of the plurality of home energy storage system units based on a unique usage pattern associated with each of the plurality of home energy storage system units.

2. The system as recited in claim 1, wherein the data repository is part of a memory device of a cloud-based server system.

3. The system as recited in claim 1, wherein the processor is part of a cloud-based server system.

4. The system as recited in claim 3, wherein the cloud-based server system includes a transceiver configured to communicate with a corresponding transceiver of each of the plurality of home energy storage system units for receiving the battery usage data.

5. The system as recited in claim 1, wherein each of the plurality of home energy storage system units includes a battery array including a plurality of battery cells, a sensor system, a communication system, and a controller.

6. The system as recited in claim 5, wherein the sensor system includes one or more sensors configured for monitoring various aspects associated with the battery cells.

7. The system as recited in claim 6, wherein the various aspects include at least temperature, voltage, and current values associated with the battery cells.

8. The system as recited in claim 1, wherein the processor is configured to derive the unique usage pattern associated with each of the plurality of home energy storage system units based on the battery usage data.

9. The system as recited in claim 1, wherein the processor is configured to predict a future life capability of each of the plurality of home energy storage system units based on the unique usage pattern.

10. The system as recited in claim 9, wherein the future life capability is further based on one or more battery degradation characteristics or one or more specifications of the plurality of home energy storage system units.

11. The system as recited in claim 1, wherein the processor is configured to determine, based on the expected impact of the new home energy storage feature on each of the plurality of home energy storage system units, which units of the plurality of home energy storage system units the new home energy storage features should be implemented on.

12. The system as recited in claim 11, wherein the processor is configured to command implementation of the new home energy storage feature on a first portion of the plurality of home energy storage system units and is further configured to command that the new home energy storage feature not be implemented on a second portion of the plurality of home energy storage system units.

13. The system as recited in claim 12, wherein the new home energy storage feature is not implemented when an overall benefit of launching the new home energy storage feature will not outweigh any negative impact imposed on a future life capability.

14. A method, comprising:
selectively determining, via a processor of a server system, whether or not to implement a new feature within a first home energy storage system unit of a plurality of home energy storage system units based on a unique usage pattern associated with the first home energy storage system unit.

15. The method as recited in claim 14, comprising:
receiving and storing battery usage data associated with the first home energy storage system unit on a data repository of the server system.

16. The method as recited in claim 15, comprising:
deriving the unique usage pattern of the first home energy storage system unit based at least on the battery usage data.

17. The method as recited in claim 16, comprising:
predicting a future life capability of the first home energy storage system unit based on the derived unique usage pattern.

18. The method as recited in claim 17, comprising:
assessing an impact of the new feature on the future life capability of the first home energy storage system unit.

19. The method as recited in claim 18, comprising:
commanding installation of the new feature on the first home energy storage system unit when the impact of implementing the new feature is within the future life capability of the first home energy storage system unit.

20. The method as recited in claim 19, comprising:
commanding that the new feature not be implemented on a second home energy storage system unit of the plurality of home energy storage system units when the impact of implementing the new feature is not within a future life capability of the second home energy storage system unit.
